(19) United States
(12) Patent Application Publication
(10) Pub. No.: US 2008/0294546 A1
(43) Pub. Date: Nov. 27, 2008

(54) SYSTEM AND METHOD FOR PEER-TO-PEER FINANCING

(76) Inventor: Matthew Flannery, San Francisco, CA (US)

Correspondence Address: HUSCH BLACKWELL SANDERS LLP, 1620 DODGE STREET, SUITE 2100, OMAHA, NE, 68102, US

(21) Appl. No.: 11/870,138

(22) Filed: Oct. 10, 2007

Related U.S. Application Data
(60) Provisional application No. 60/829,111, filed on Oct. 11, 2006.

(51) Int. Cl. G06Q 40/00

(52) U.S. Cl. 705/38; 705/35

(57) ABSTRACT

A system and method for an online, peer-to-peer lending platform for microfinance is disclosed. Through the system and method of the present invention, individual and personal lenders across the world can uniquely loan to specific micro-enterprises in many countries and geographic areas in a highly personal and effective manner. This system and method functions as a unique bridge between individual lender and borrower by providing elements and steps for facilitating and processing microfinance institution (MFI) transactions.

### CROSS-REFERENCE TO RELATED APPLICATIONS

The present Application claims the benefit of and priority as available under 35 U.S.C. § 119 to U.S. Provisional Patent Application 60/829,111, filed Oct. 11, 2006, which is incorporated by reference in its entirety.

### BACKGROUND OF INVENTION

1. Field of Invention

This invention relates generally an online peer-to-peer lending platform, microfinance investing, and philanthropy.

2. Background Art

Microfinance is a known tool for fighting poverty but the unequal distribution of available microfinance capital restricts the ability of many microfinance institutions to best serve their clientele while achieving financial sustainability. Capital from the retail Western investor who value an emotional return, not just a financial return (as banks do), can allow strong microfinance institutions to develop capacity to become financially self-sufficient and allow up-and-coming microfinance institutions to expand client access to capital.

Today, more than 1 billion people subsist on less than $1 a day, the bare minimum of material subsistence. (The Millennium Development Goals Report, 2005) While comprehensive impact studies have demonstrated that “the use of financial services by low-income households is associated with improvements in household economic welfare and enterprise stability or growth,” fewer than 2% of poor people have access to financial services from sources other than informal, usurious money lenders. (United Nations Capital Development Fund: Basic Facts About Microfinance; Data Snapshots on Microfinance—The Virtual Library on Microcredit)

Incredible success stories from institutions such as the Bangladesh-based Grameen Bank imply that most microfinance institutions have the capacity necessary to financially break-even while serving the poor. However, rising MFI's without access to debt face a capital trap restricting their ability to serve micro-entrepreneurs or scale to reach long term sustainability.

Grameen Bank and Acciòn in fact exist at the top of a microfinance pyramid. As a distinct minority, these elite MFI's have expansive access to capital and sufficient capacity. However, Tier 2 microfinance institutions, those that could become financially self-sufficient with increased capacity, face high capital costs preventing them from achieving net revenues necessary to expand to break-even equilibrium. Tier 3 microfinance institutions face still greater constraints in completely restricted access to capital and unfulfilled capacity.

The wealth of capital seemingly available to microfinance institutions is distributed unequally among MFIs. Mike Murray, Chairman of Unitus, contends that Tier 1 MFIs often have access to an excess of debt capital while Tier 2 MFIs, which might be equally capable of handling such debt capital, remain in need.

In order to meet the demand for micro-credit, new and personal debt capital—coming from individuals not banks—must be raised and distributed efficiently to those MFI's currently undeserved by the microfinance market. Access to debt capital for Tier 2 and 3 MFI's can build capacity within these institutions to enhance efficiency and financial sustainability. Moreover, personal debt capital can provide these MFI's with the resources to develop their operations more rapidly to expand micro-credit access and achieve sustainability sooner.

### BRIEF SUMMARY OF INVENTION

The present invention comprises an online peer-to-peer lending platform. In an embodiment of the present invention, the online peer-to-peer lending platform connects online users to low-income entrepreneurs in need of micro-loans. By leveraging the internet, online payments, partnerships with local microfinance institutions (MFI's), and personal lending, the present invention enables lenders to fund new micro-businesses and assist MFI's with capacity development.

The present invention comprises quality MFIs that post to the internet information on micro-entrepreneurs in need of micro-loans. Users of the present invention browse entrepreneurs online and send loan funds to entrepreneurs of their choosing through the platform provided by the present invention. According to the system and method of the present invention, loan funds are sent to MFIs who manage and administer the loan for funded micro-enterprises. As loan repayments are made by the entrepreneur, the MFI sends repayments back to the system and method of the present invention and, on full repayment of a loan, the system and method of the present invention credits lenders for the total loan funds they extended. Users may choose to reloan to another business, donate the balance of their repayment to an entity practicing the present invention, or withdraw their credit from the system.

The present invention comprises an online, peer-to-peer lending platform for microfinance. Through the system and method of the present invention, lenders across the world can uniquely loan to specific micro-enterprises in developing countries in a highly personal and effective manner. This system and method functions as the critical bridge between lender and borrower by leveraging its interactive website and microfinance institution (MFI) partnerships.

Visitors to an internet website that implements the system and method of the present invention view capital-seeking micro-enterprises and may offer zero percent interest loans in increments of $25, or discrete U.S. dollar amounts. In another embodiment, loans may be offered to lenders for more than zero percent interest and such legal issues are currently being investigated. In another embodiment, lenders receive a zero percent rate of return and borrowers are required to pay non-zero interest rates set by the local MFI. In this embodiment, the difference between the lender interest rate and the interest rate faced by borrowers is captured by the local MFI to improve operations, expand credit access, or reach out to new borrower populations. In another embodiment, lenders receive more than zero percent interest and borrowers are required to pay non-zero interest rates set by the local MFI. In this embodiment, the difference between the lender interest rate and the interest rate faced by borrowers is captured by the local MFI to improve operations, expand credit access, or reach out to new borrower populations.

To ensure that loans administered by the system and method of the present invention are being handled responsibly, all micro-enterprises are reviewed by a local, sponsoring MFI that partners directly with an entity practicing the present invention. An MFI may post micro-enterprises on the present invention in order to raise loan capital from individual lenders. micro-enterprise In one embodiment, the MFI will wait for the funds to be aggregated from lenders before disbursing the loan capital to the micro-enterprise. In another embodiment, the MFI will backfill a loan they have already made to the micro-enterprise using locally available working capital. The backfilled funds will lower their total cost of capital.may seek a loan of any size and when a posted business receives the capital it seeks, the loan is fully executed and repaid over a 6-12 month period.

Throughout the course of a loan term for a specific micro-enterprise posted and fully funded on the present invention, sponsoring MFI's post micro-enterprise journal entries directly to a website of the system and method of the present invention for the enjoyment of lenders. Many microfinance institutions require that individuals repay loans in small increments throughout a 4-24 month period and all borrower repayments are manually noted and updated on the website by the MFI. In another embodiment, borrower repayments are automatically noted on the site by the system and method of the present invention in order to reduce administration cost for the MFI. The system and method of the present invention invoices the MFI for the posted repayments to the site for each micro-enterprise on a set interval (monthly, every two months, etc.) in order to collect funds owed to the present invention and end lenders. Once MFIs transfer funds back to the present invention, the present invention allows lenders to reclaim their funds. Lenders have the option to reclaim their funds by withdrawing it from the present invention (the present invention is a stored value system) or by re-lending the funds to another micro-enterprise.

Performance of MFI partners and borrowers is closely tracked on the website through a reputation system. For instance, the repayment rate of each MFI is visible on a web page dedicated specifically to that MFI partner. Also, the past borrowing history of an entrepreneur is visible on a web page dedicated to that particular borrower. These reputations can be browsed by internet lenders so they can make an informed assessment of the risk of a particular loan opportunity.

Performance of MFI partners and borrowers is closely tracked on the website through a reputation system. For instance, the repayment rate of each MFI is visible on a web page dedicated specifically to that MFI partner. Also, the past borrowing history of an entrepreneur is visible on a web page dedicated to that particular borrower. These reputations can be browsed by internet lenders so they can make an informed assessment of the risk of a particular loan opportunity.

After a loan application, or business, is uploaded, the software divides the loan amount of each business into smaller “shares”. In one embodiment, these shares are priced at $25. Users can then purchase fragments so that many users can essentially own a larger loan. Users get repaid according to the number of shares they have purchased.

The website partner interface includes a tool for partners to record payments made by their borrowers to them. Recording these payments produces payment notification emails which are sent to the lenders to the borrower for which the payment is recorded. This tool allows for partners to specify that payments happen automatically according to a schedule that the partner defines. Partners can interrupt the auto-payment recording feature if an entrepreneur fails to pay back a loan on a given month.

After a loan application, or business, is uploaded, the software divides the loan amount of each business into smaller “shares”. In one embodiment, these shares are priced at $25. Users can then purchase fragments so that many users can essentially own a larger loan. Users get repaid according to the number of shares they have purchased.

The system also allows for MFI partners to record data to the website via cell phones using MMS and text messaging technology. Staff at MFI partners can send messages—via local cell phones—to an email address. The messages are received at a server and uploaded to the website. Both pictures and text can be uploaded using this method. Partner MFIs may use this technology to record payment information or other qualitative data to the site.

These and other advantageous features of the present invention will be in part apparent and in part pointed out herein below.

### BRIEF DESCRIPTION OF THE DRAWINGS

For a better understanding of the present invention, reference may be made to the accompanying drawings in which:

FIG. 1 is an illustration of the system and method with regard to individual lenders;

FIG. 2 is a timeline illustration of the steps and elements of an embodiment of a method and system of the present invention;

FIG. 3 is a Your Basket page from one embodiment of the present invention.

FIG. 4 is a Featured Businesses page from one embodiment of the present invention.

FIG. 5 is an Overview page from one embodiment of the present invention.

FIG. 6 is a Business page from one embodiment of the present invention.

FIG. 7 is a MFI information page from one embodiment of the present invention.

FIG. 8 is a My Business page from one embodiment of the present invention.

FIG. 9 is a Find Businesses page from one embodiment of the present invention.

FIG. 10 is an Advanced Find Businesses page from one embodiment of the present invention.

FIG. 11 is a Partner Specific View Find Businesses page from one embodiment of the present invention.

FIG. 12 is a Partner Content page from one embodiment of the present invention.

FIG. 13 is a Partner Admin page from one embodiment of the present invention.

FIG. 14 is a Partner Info page from one embodiment of the present invention.

FIG. 15 is the elements of the Partner Info page of FIG. 14.

### DETAILED DESCRIPTION OF INVENTION

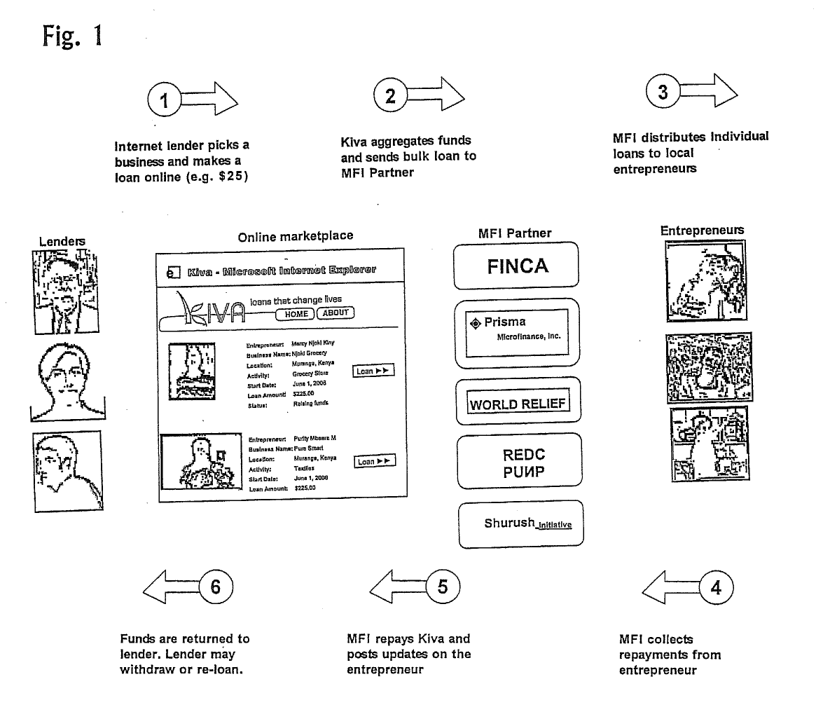

According to the embodiment(s) of the present invention, various views are illustrated in FIG. 1-8 and like reference numerals are being used consistently throughout to refer to like and corresponding parts of the invention for all of the various views and figures of the drawing. Also, please note that the first digit(s) of the reference number for a given item or part of the invention should correspond to the Fig. number in which the item or part is first identified.

The present invention comprises an online peer-to-peer lending platform. In an embodiment of the present invention, the online peer-to-peer lending platform connects online users to low-income entrepreneurs in need of micro-loans. By leveraging the internet, online payments, partnerships with local microfinance institutions (MFI's), and personal lending, the present invention enables lenders to fund new micro-businesses and assist MFI's with capacity development.

The present invention comprises quality MFIs that post to the internet information on micro-entrepreneurs in need of micro-loans. Users of the present invention browse entrepreneurs online and send loan funds to entrepreneurs of their choosing through the platform provided by the present invention. According to the system and method of the present invention, loan funds are sent to MFIs who manage and administer the loan for funded micro-enterprises. As loan repayments are made by the entrepreneur, the MFI sends repayments back to the system and method of the present invention and, on full repayment of a loan, the system and method of the present invention credits lenders for the total loan funds they extended. Users may choose to reloan to another business, donate the balance of their repayment to an entity practicing the present invention, or withdraw their credit from the system.

The present invention comprises an online, peer-to-peer lending platform for microfinance. Through the system and method of the present invention, lenders across the world can uniquely loan to specific micro-enterprises in developing countries in a highly personal and effective manner. This system and method functions as the critical bridge between lender and borrower by leveraging its interactive website and microfinance institution (MFI) partnerships.

Visitors to an internet website that implements the system and method of the present invention view capital-seeking micro-enterprises and may offer zero percent interest loans in increments of $25, or discrete U.S. dollar amounts. In another embodiment, loans may be offered to lenders for more than zero percent interest and such legal issues are currently being investigated. In another embodiment, lenders receive a zero percent rate of return and borrowers are required to pay non-zero interest rates set by the local MFI. In this embodiment, the difference between the lender interest rate and the interest rate faced by borrowers is captured by the local MFI to improve operations, expand credit access, or reach out to new borrower populations. In another embodiment, lenders receive more than zero percent interest and borrowers are required to pay non-zero interest rates set by the local MFI. In this embodiment, the difference between the lender interest rate and the interest rate faced by borrowers is captured by the local MFI to improve operations, expand credit access, or reach out to new borrower populations.

To ensure that loans administered by the system and method of the present invention are being handled responsibly, all micro-enterprises are reviewed by a local, sponsoring MFI that partners directly with an entity practicing the present invention. An MFI may post micro-enterprises on the present invention in order to raise loan capital from individual lenders. micro-enterprise In one embodiment, the MFI will wait for the funds to be aggregated from lenders before disbursing the loan capital to the micro-enterprise. In another embodiment, the MFI will backfill a loan they have already made to the micro-enterprise using locally available working capital. The backfilled funds will lower their total cost of capital.may seek a loan of any size and when a posted business receives the capital it seeks, the loan is fully executed and repaid over a 6-12 month period.

Throughout the course of a loan term for a specific micro-enterprise posted and fully funded on the present invention, sponsoring MFI's post micro-enterprise journal entries directly to a website of the system and method of the present invention for the enjoyment of lenders. Many microfinance institutions require that individuals repay loans in small increments throughout a 4-24 month period and all borrower repayments are manually noted and updated on the website by the MFI. In another embodiment, borrower repayments are automatically noted on the site by the system and method of the present invention in order to reduce administration cost for the MFI. The system and method of the present invention invoices the MFI for the posted repayments to the site for each micro-enterprise on a set interval (monthly, every two months, etc.) in order to collect funds owed to the present invention and end lenders. Once MFIs transfer funds back to the present invention, the present invention allows lenders to reclaim their funds. Lenders have the option to reclaim their funds by withdrawing it from the present invention (the present invention is a stored value system) or by re-lending the funds to another micro-enterprise.

Performance of MFI partners and borrowers is closely tracked on the website through a reputation system. For instance, the repayment rate of each MFI is visible on a web page dedicated specifically to that MFI partner. Also, the past borrowing history of an entrepreneur is visible on a web page dedicated to that particular borrower. These reputations can be browsed by internet lenders so they can make an informed assessment of the risk of a particular loan opportunity.

Performance of MFI partners and borrowers is closely tracked on the website through a reputation system. For instance, the repayment rate of each MFI is visible on a web page dedicated specifically to that MFI partner. Also, the past borrowing history of an entrepreneur is visible on a web page dedicated to that particular borrower. These reputations can be browsed by internet lenders so they can make an informed assessment of the risk of a particular loan opportunity.

After a loan application, or business, is uploaded, the software divides the loan amount of each business into smaller “shares”. In one embodiment, these shares are priced at $25. Users can then purchase fragments so that many users can essentially own a larger loan. Users get repaid according to the number of shares they have purchased.

The website partner interface includes a tool for partners to record payments made by their borrowers to them. Recording these payments produces payment notification emails which are sent to the lenders to the borrower for which the payment is recorded. This tool allows for partners to specify that payments happen automatically according to a schedule that the partner defines. Partners can interrupt the auto-payment recording feature if an entrepreneur fails to pay back a loan on a given month.

After a loan application, or business, is uploaded, the software divides the loan amount of each business into smaller “shares”. In one embodiment, these shares are priced at $25. Users can then purchase fragments so that many users can essentially own a larger loan. Users get repaid according to the number of shares they have purchased.

The system also allows for MFI partners to record data to the website via cell phones using MMS and text messaging technology. Staff at MFI partners can send messages—via local cell phones—to an email address. The messages are received at a server and uploaded to the website. Both pictures and text can be uploaded using this method. Partner MFIs may use this technology to record payment information or other qualitative data to the site.

In one embodiment of the present invention, a lender visits the website implementing the system and method of the present invention. At the website the lender registers. During the registration, the lender provides, inter alia, basic demographic and contact information. The lender is provided a username and password to utilize on subsequent visits to the website.

Lenders browse a list of possible loan opportunities listed on the website. The loan opportunities can be grouped by partner organization, region, industry, etc. Featured micro-enterprises typically include the following attributes: Description of the business to be started; Name of individual entrepreneurs associated with the business; Name of the sponsoring microfinance institution; Pictures of the entrepreneur; Amount of total startup capital needed; How the loan will be used; and/or Duration of loan repayment.

In an embodiment, payments for loans are made using credit cards or a Paypal account or other internet-implemented transaction processing system. In a further embodiment, payments for loans are facilitated using Paypal (or other internet-implemented transaction processing system) as the processor.

Throughout the duration of loan repayment, lenders are sent regular email updates about the progress of their respective loan recipient. Progress is recorded in text reports and pictures. Reports are given in monthly or quarterly increments. Once a new update has been posted, lenders receive an email alerting them and may continuously see what loan repayments have been made.

Lenders are given the option of communicating with a micro-enterprise through the mediation of a sponsoring MFI representative. This dialogue occurs through comments made to a journal entry.

Once the proposed duration of the loan has expired the loan becomes “redeemed.” A redeemed loan turns into “Credit” in the user's account. With Credit, a user can do the following: (1) Withdraw and receive a Paypal payment; (2) Donate the credit to the entity practicing the invention to help defer administrative costs; (3) Re-loan the balance to a new Entrepreneur; or (4) a combination thereof.

FIG. 1 illustrates a further example of the embodiments of the present invention. As shown in FIG. 1, an internet lender picks a business on the website and makes a loan online (e.g., $25). The system and method of the present invention aggregates funds and sends a bulk loan to an MFI. The MFI disburses individual loans to local entrepreneurs. The MFI collects repayments from the entrepreneur. The MFI then repays the entity practicing the system and method of the present invention. The MFI also posts updates regarding the entrepreneur on the website. Once the MFI repays the entity, the funds are returned to the lender. The lender may then withdraw, re-loan, etc., as discussed further above.

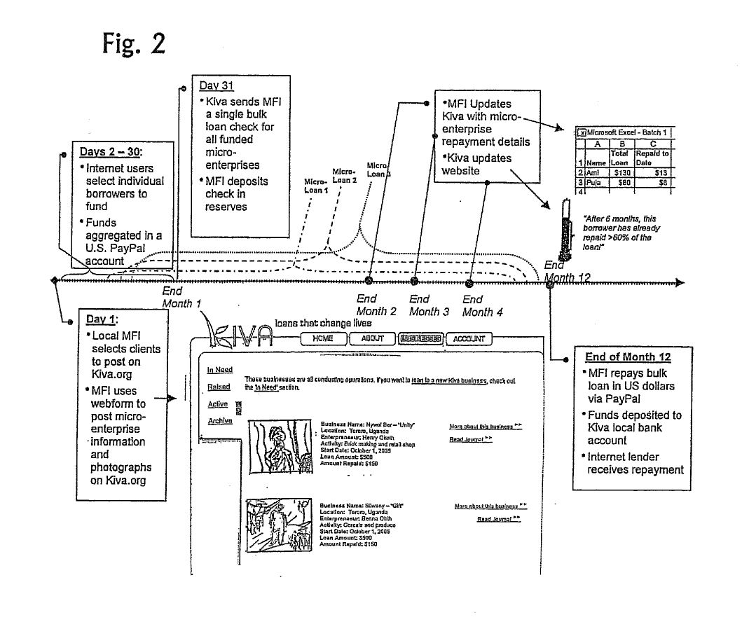

FIG. 2 provides a timeline illustration of the steps and elements of an embodiment of a method and system of the present invention. As shown in FIG. 2, with regard to Day 1, a local MFI selects clients to post on the website of the present invention. The MFI uses a webform to post micro-enterprise information and photographs on the website. With regard to Day 2-30, individual internet users select individual borrowers to fund. The funds are aggregated into an account with an online internet-implemented payment processing system, such as PayPal. With regard to Day 31, the system and method of the present invention sends the MFI a single bulk loan check for all funded micro-enterprises. The MFI deposits the check in reserves. During the terms of the various micro-loans (see Micro-Loan 1, Micro-Loan 2, and Micro-Loan 3, in FIG. 2), the MFI provides informational updates to the system and method of the present invention. These informational updates are posted on the website. With regard to End of Month 12, the MFI repays the bulk loan in a specified currency using an online internet-implemented payment processing system, such as PayPal. The funds are deposited in a local bank account. The individual internet user then receives repayment.

In a further embodiment of the present invention, MFIs list businesses directly to the website through administrative web access. In this embodiment, the system and method of the present invention receives loaned funds into an account with an online internet-implemented payment processing system, such as PayPal. Then, at the end of each month, the money is dispersed to MFIs with funded, listed businesses. For MFIs with domestic offices, checks can be utilized for payment processing. For foreign MFIs, wire transfer or an online internet-implemented payment processing system, such as PayPal, can be utilized.

In one embodiment, MFIs are billed every month for the net balance, in a specified currency, that the MFI has listed as being repaid within the previous month (i.e., repayments from MFI-sponsored microenterprises, or newly loaned money to MFI-sponsored microenterprises). This net balance may require that the MFI be paid some months, while in other months the MFI is repaying money.

According to an embodiment of the present invention, individual businesses, entrepreneurs, and/or microenterprises (and their corresponding loans) can be processed and categorized into several classes of status. These classes comprise: refunded; deleted; inactive; fundraising; raised; payingBack; and/or ended.

The class comprising refunded indicates that the corresponding business and/or loan did not make it to payingBack status. This class further indicates that the money was returned to the lenders. As discussed below, in this embodiment a loan will only be refunded for the fundraising and raised classes. Businesses that are categorized as refunded are “stuck” here and cannot receive a further classification without further determination by the system.

The class comprising deleted designates that the business was deleted by a step or an administrator of the present invention. Only loans that are inactive can be deleted by using the “Activate/Delete” page (see Fig.). deleted businesses are “stuck” with this classification and cannot receive a further classification without further determination by the system. An administrator of the system can view a “Deleted Businesses” page.

The class comprising inactive designates that the businesses are not yet classified as fundraising. In addition to being classified by a step in the method or element of the system, business can also receive this designation by being uploaded by an MFI or administrator of the system to the website. Inactive businesses are awaiting further system processing and approval to be designated fundraising. The system can process an inactive business to fundraising. The system can also process an inactive business to deleted. An administrator of the system can view a “Activate/Delete” page.

The class comprising fundraising designates that the business is on the “in need” page of the website. A fundraising business can be further processed to refunded by the system. A fundraising business can be processed to raised when individual lenders have fully funded the business' loan request amount.

The class comprising raised designates that the corresponding loan amount has been fully funded or raised. A business is processed to this designation by the system when the loan amount has been fully funded by lenders. The system can also process the fully funded amount to refund a raised business. The system processes the raised loan to payingBack class when the loan has been disbursed.

The class comprising payingBack designates that the corresponding loan is in the state of being paid back. The system processes the loan and/or business to payingBack when the loan is disbursed. According to the system, a payingBack business can be ended when the loan is fully repaid (e.g., when the payments posted by the MFI total the loan amount). The system can also classify a business to ended prior to the loan being fully paid back. For example, the business and/or loan can be classified as ended by the system if it has exceeded the loan term length.

The class comprising ended designates that the corresponding loan is no longer being paid back. Businesses can be processed to this designation by the system when the loan is fully paid off or if other criterion is met for classifying the loan as ended. For example, loans are classified as ended when they have reached the long end loan term.

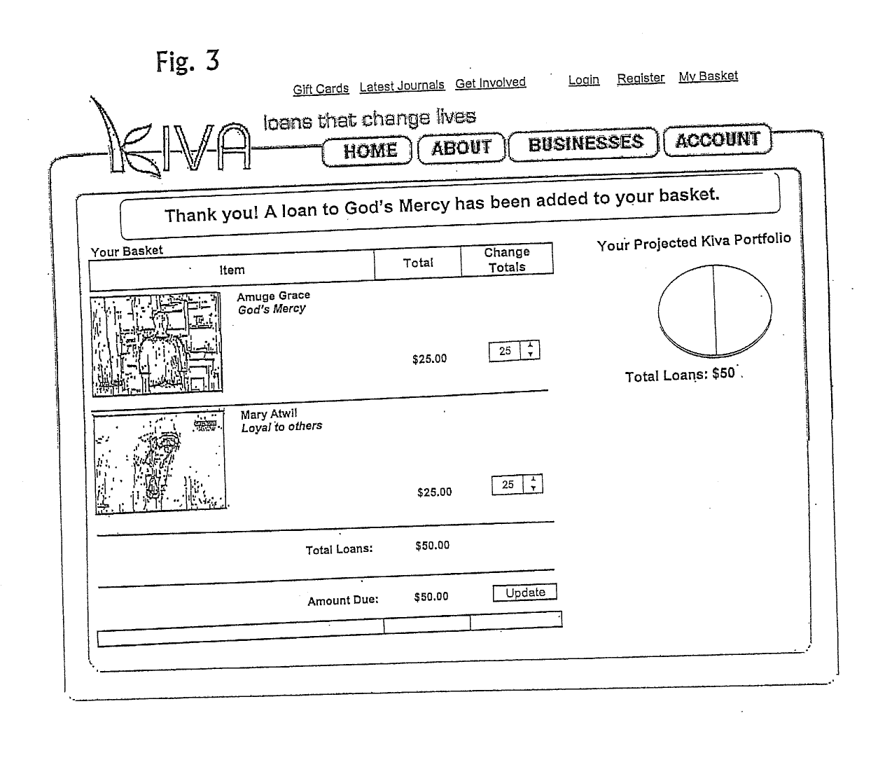

FIG. 3 is a Your Basket page from one embodiment of the present invention. This page provides an individual with a summary of loans that have been made to businesses. A picture corresponding to the business is provided. The business representative, business name, and MFI are also provided. On this page, the loans have not yet been finalized. As such, the loan totals may still be changed by the individual prior to finalization (i.e., clicking the “Update” button). A graph shows a projected portfolio of loaned funds after finalization.

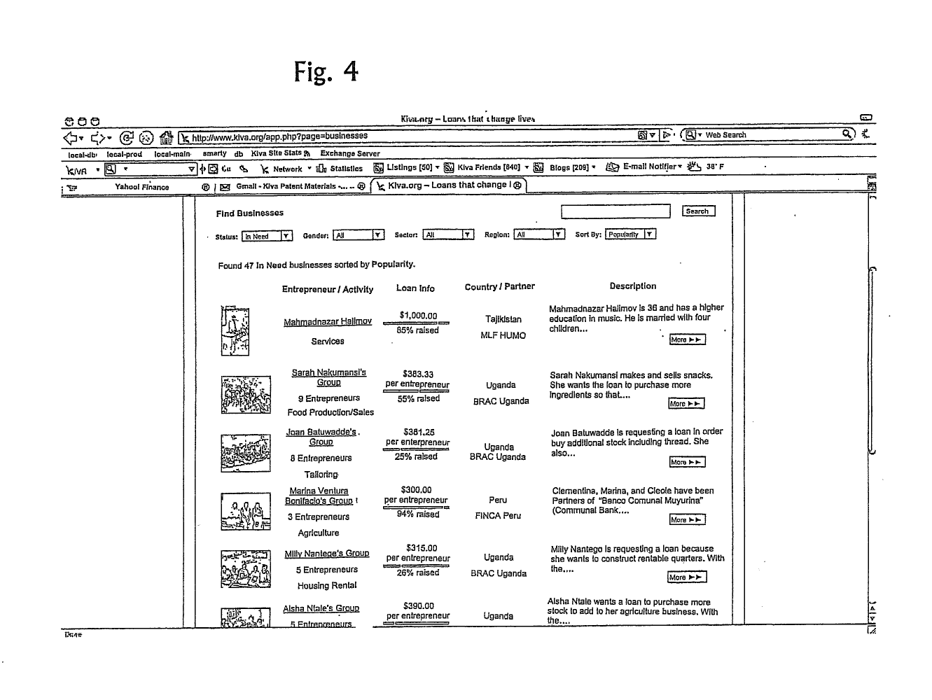

FIG. 4 is a Featured Businesses page from one embodiment of the present invention. This page provides an individual with a summary of businesses and corresponding loans that are awaiting further funds. A picture corresponding to the business is provided. A business representative name is provided, as well as a location of the business. The amount of loan requested is provided. A percentage of amount of loan that has been funded is provided. A description of the business and/or business representative and/or purpose for the loan request is provided.

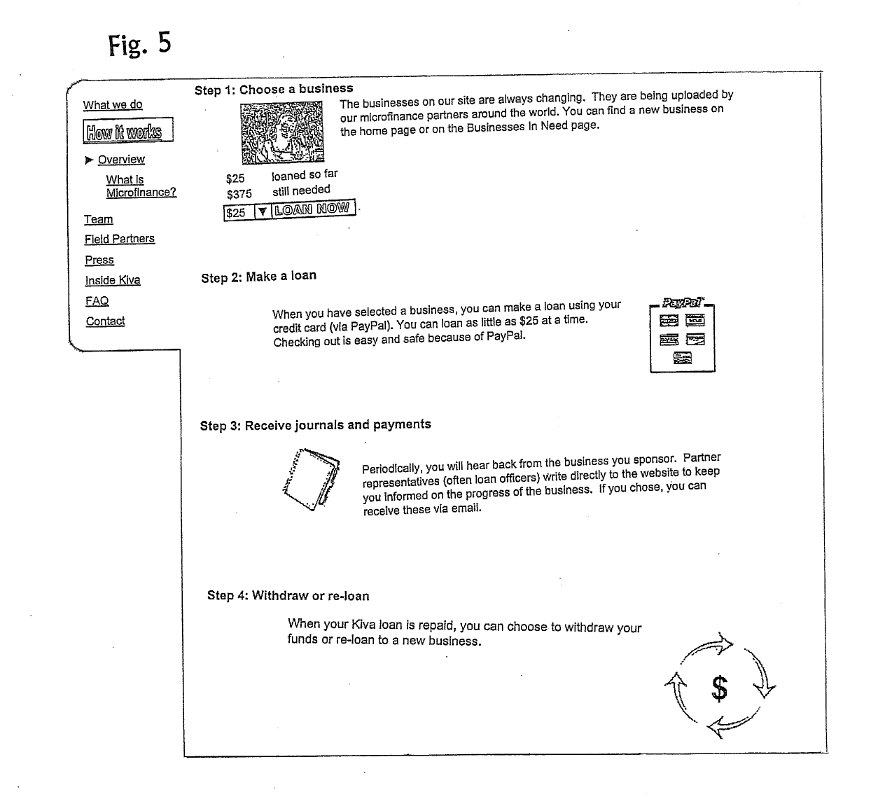

FIG. 5 is an Overview page from one embodiment of the present invention. This page provides an individual with various steps involved in providing a loan to a business and receiving repayment on the loan.

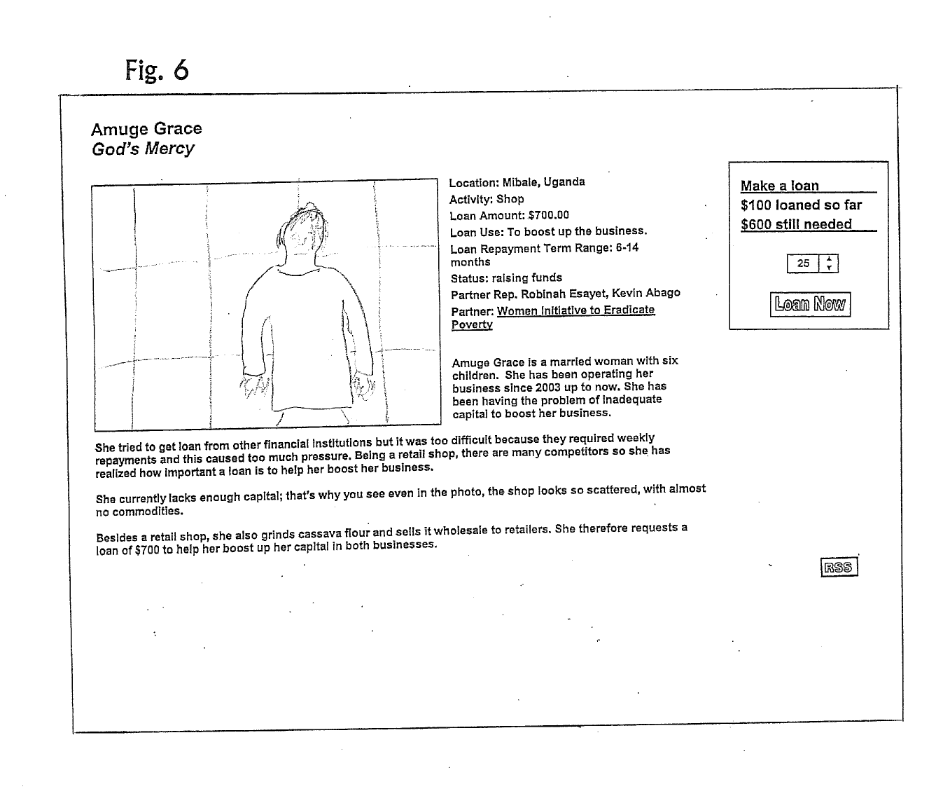

FIG. 6 is a Business page from one embodiment of the present invention. Information regarding the business and purpose for the loan are provided. The class of the business is provided. The repayment terms and MFI (i.e., partner) information is provided.

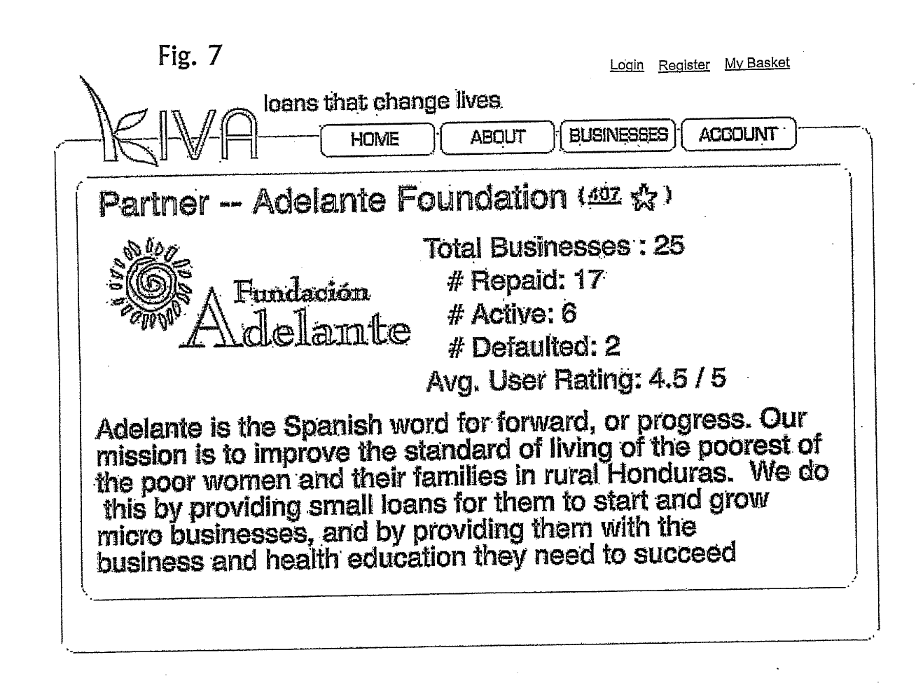

FIG. 7 is a MFI information page from one embodiment of the present invention. This page provides information regarding the MFI (i.e., partner). The total number of businesses funded is provided, as well as a breakdown regarding how many of those businesses have repaid loans, have active loans, or have defaulted on loans. Individuals can provide comments. On this page there are 407 comments regarding the MFI. The individuals can also rate their satisfaction with the MFI. This page provides the average rating from individuals for this MFI.

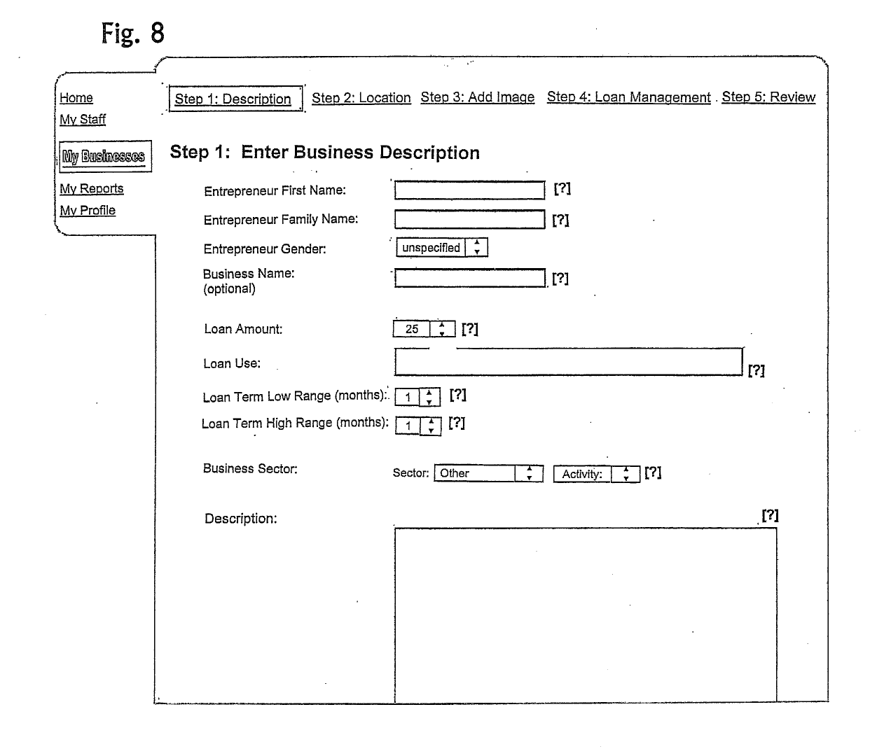

FIG. 8 is a My Business page from one embodiment of the present invention. This page provides a form for inputting information regarding a business into the system of the present invention. Information included comprises entrepreneur first and family name, gender, business name, requested loan amount, loan use, the loan term time limits, the business sector of the business, and a description of the business and/or purpose of the requested loan.

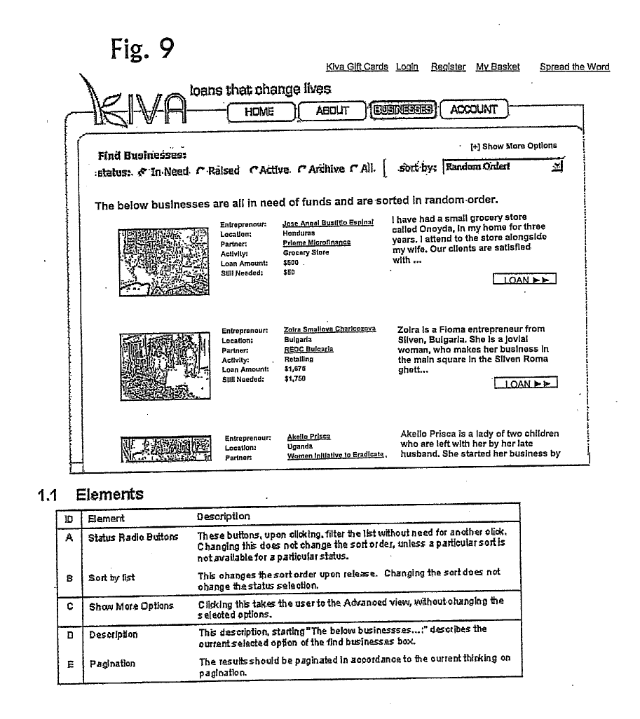

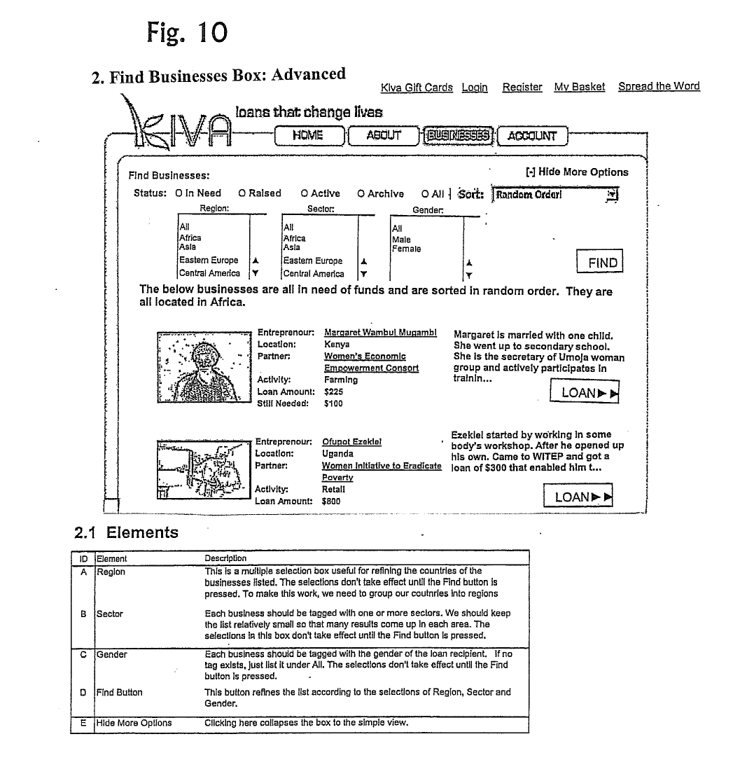

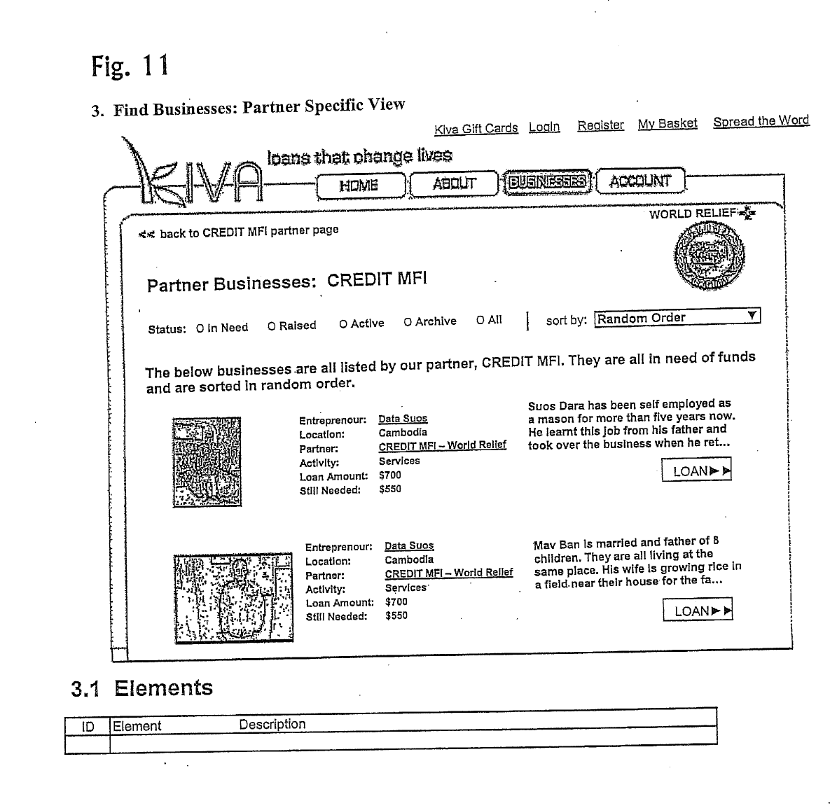

FIG. 9 is a Find Businesses page from one embodiment of the present invention. This page allows users to filter and sort the businesses section of the website in more refined ways. This embodiment has three basic views: Simple (FIG. 9), Advanced (FIG. 10), and Partner Specific (FIG. 11). In addition to filtering, in a further embodiment, searching is provided.

FIG. 10 is an Advanced Find Businesses page from one embodiment of the present invention.

FIG. 11 is a Partner Specific View Find Businesses page from one embodiment of the present invention.

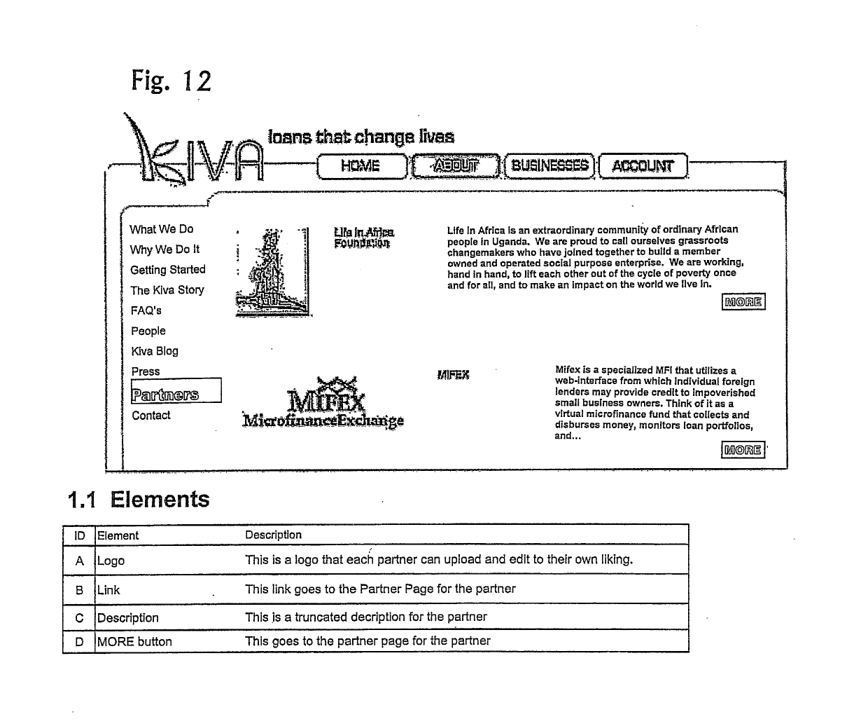

FIG. 12 is a Partner Content page from one embodiment of the present invention. This page provides a list of partners (i.e., MFIs), a page for each partner and a facility for each partner to upload partner specific content. In a further embodiment, this page includes a partner journal and the ability for each user to see all businesses listed by partner.

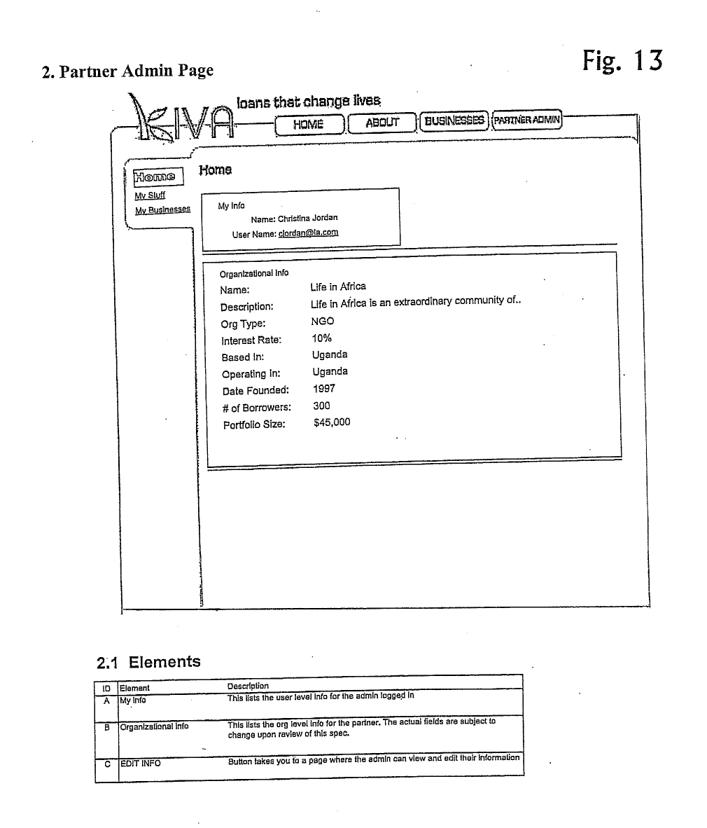

FIG. 13 is a Partner Admin page from one embodiment of the present invention.

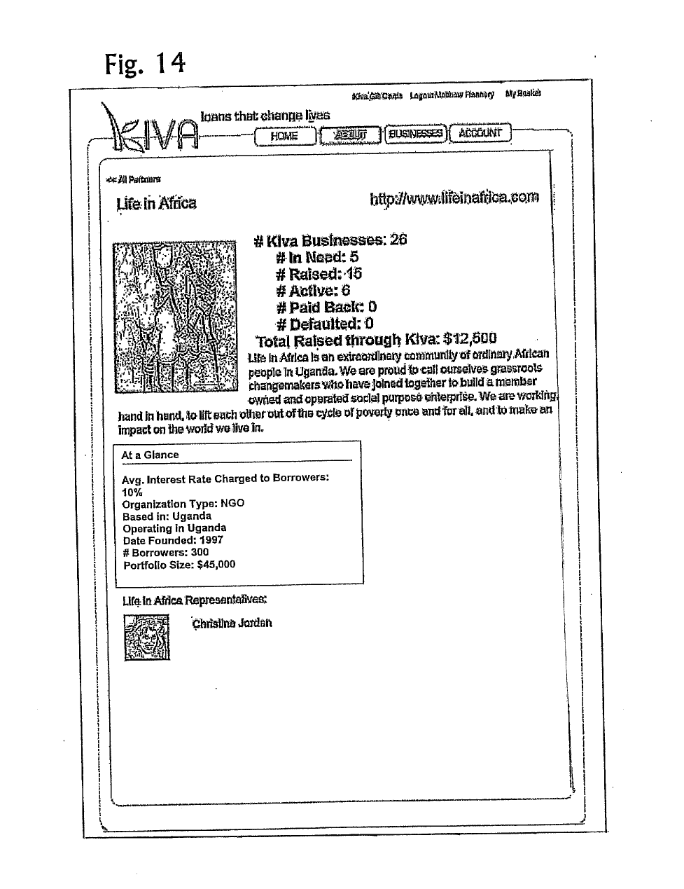

FIG. 14 is a Partner Info page from one embodiment of the present invention.

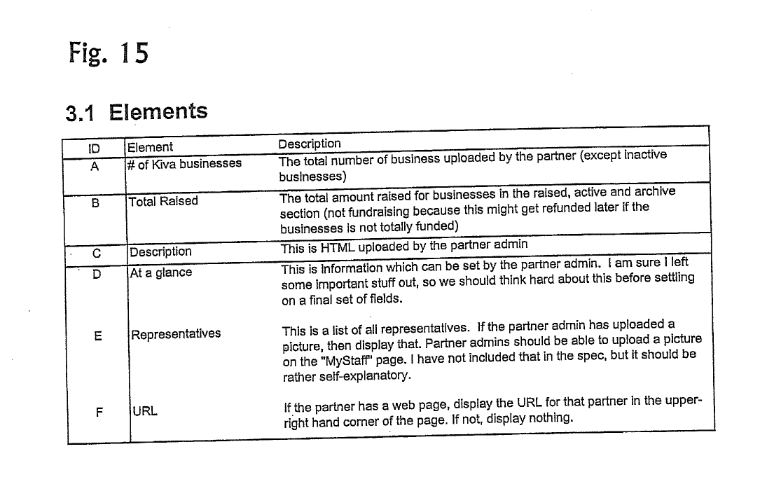

FIG. 15 is the elements of the Partner Info page of FIG. 14.

The present invention has at least several advantages over previously attempted solutions to the problems addressed by the system and method of the present invention. For example, by leveraging the existing infrastructure and expertise of microfinance institutions to vet entrepreneurs and administer loans, the present invention gains MFIs' depth and specialization of experience critical to loan administration and repayment success. Were the system and method of the present invention to operate as a microfinance institution, it would enter the market decades behind many well-equipped MFIs that have documented success with microfinance. Furthermore, current local MFIs have acquired critical knowledge of the populations with which they work that the present invention can best leverage in partnership, not in competition. The developing world is heterogeneous economically, politically, and culturally and a diversity of partner microfinance institutions is best equipped to adjust to the practical realities of global microfinance.

An example of another advantage is that an embodiment of the present invention comprises an internet platform for peer-to-peer microfinance lending. This embodiment brings a competitive advantage in technology, marketing, relationships and brand. Specialization in this sector is mutually beneficial and allows MFI's to continue capacity-building while achieving important economies of scale necessary to become financially sustainable.

Another example of advantages is that the previously known microfinance sector consists of direct contributions to microfinance institutions and microfinance bonds offered by institutions such as Calvert. Loans administered through the present invention differentiate themselves from direct contributions to microfinance institutions by offering lenders an opportunity to recoup their investment and/or lend indefinitely. Lenders are therefore presented with an opportunity for low-cost philanthropy (including only capital opportunity costs and default risk) and sustainable impact.

Another advantage is that previously known institutions such as Calvert have pioneered investment mechanisms in microfinance by offering bonds to individuals in amounts of more than $1,000 per note. Loans administered by the present invention critically differ from these investments by offering individual lenders, particularly those of more limited means, and opportunity to offer micro-loans to impoverished microentrepreneurs in denominations of $25. This difference allows the present invention to open up microfinance philanthropic investing to those without the ability to invest in $1,000 denominations.

In contrast to previously known institutional investments, loans administered under the present invention also serve clients sponsored by the thousands of microfinance institutions not within the top 100 MFI's. These microfinance institutions often are not able to access capital from Calvert-like investment vehicles and loans comprised by the present invention thus present a scarce and unique opportunity to loan to clients not likely to be served by others.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the present invention.

Other aspects, objects and advantages of the present invention can be obtained from a study of the drawings, the disclosure and the appended claims.

What is claimed is:

1. A system for providing financing to a borrower in the form of a loan comprising:
at least one interface for receiving and providing information about the borrower over the Internet to a user wherein the information about the borrower comprises the borrower's location, the type of business the borrower will engage in, and information on the microfinancial institution that would distribute the loan funds to the borrower;
a server for providing, through the at least one interface, information to the user to provide financing to the borrower;
wherein the interface is configured for the user to select the borrower and identify an amount of money to be lent to the borrower.

2. The system of claim 1, wherein the information about the borrower further comprises borrower reputation information.

3. The system of claim 1, wherein the information on the microfinancial institution comprises reputation information.

4. The system of claim 1, wherein the user is a lender.

5. The system of claim 4, wherein the lender may select form a plurality of borrowers.

6. The system of claim 4, wherein funds provided by a plurality of lenders are agglomerated into a single loan made to the borrower.

7. The system of claim 1, wherein the borrower information is provided by a microfinancial institution.

8. The system of claim 1, wherein funds repaid by the borrower may be relent by the lender.

9. A method for computer-implemented microfinancing comprising:
compiling information regarding a plurality of loan opportunities, each loan opportunity corresponding to a business borrower, from one or more microfinancial institutions;
providing the information regarding the plurality of loan opportunities to a plurality of lenders;
selecting one of the plurality of loan opportunities based on input from one or more of the plurality of lenders who have selected the one of the plurality of loan opportunities;
agglomerating funds from the one or more plurality of lenders to the business borrower corresponding to the one of the plurality of loan opportunities; and
transmitting the funds to the business borrower.

10. The method of claim 9, wherein the information regarding the plurality of loan opportunities comprises the type of business the borrower will engage in, repayment terms, and borrower reputation information based upon past performance of the business borrower.

11. The method of claim 10, wherein the borrower reputation information includes information regarding repayment of past loans.

12. The method of claim 9, further comprising providing the lender with reputation information about the microfinancial institution.

13. A storage medium for storing a computer program that is executable by a processor for performing the following:
receiving information regarding a plurality of borrowers over the Internet from one or more microfinancial institutions
providing the information regarding a plurality of borrowers over the Internet to a user via at least one interface;
providing, through the at least one interface, information to the user to provide financing to one or more of the borrowers;
selecting one of the plurality of borrowers and an amount to be loaned to the one of the plurality of borrower based upon input from the user;
providing information to a microfinancial institution identifying the one of the plurality of borrowers selected by the user and the amount to be loaned.

14. The storage medium of claim 13, wherein the information regarding the plurality of borrowers comprises the type of businesses the borrowers will engage in and repayment terms.

15. The storage medium of claim 14, wherein the information regarding the plurality of borrowers further comprises borrower reputation information based upon past performance of each of the plurality of borrowers.

16. The storage medium of claim 15, wherein the borrower reputation information includes information regarding repayment of past loans.

17. The storage medium of claim 13, wherein the program is capable of providing the lender with reputation information about the microfinancial institution.

18. The storage medium of claim 13, wherein the program is capable of agglomerating loan amounts from a plurality of lenders who have selected the same borrower.
